(19) United States
(12) Patent Application Publication
(10) Pub. No.: US 2009/0172672 A1
(43) Pub. Date: Jul. 2, 2009

(54) SYSTEM AND METHOD FOR APPROVING A TASK FILE VIA A MOBILE PHONE

(75) Inventors: CHUNG-I LEE, Tu-Cheng (TW); CHIU-HUA LU, Tu-Cheng (TW); ZHE-XIN LIU, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (SHENZHEN) CO., LTD, Shenzhen City (CN); HON HAI PRECISION INDUSTRY CO., LTD., Tu-Cheng (TW)

(21) Appl. No.: 12/338,956

(22) Filed: Dec. 18, 2008

(30) Foreign Application Priority Data
Dec. 28, 2007 (CN) 200710203507.7

(51) Int. Cl. G06F 9/46

(52) U.S. Cl. 718/100

(57) ABSTRACT

An application server is included in a system for approving a task file via a mobile phone. The application server provides a storage system for storing at least one task, each of the at least one task includes at least one task file. The application server is configured for providing message sending function, task selecting function, information analyzing function, and file processing function to the mobile phone to approve a task file in the storage system.

### BACKGROUND

1. Technical Field

Embodiments of the present disclosure relate to systems and methods for processing a task file, and more particularly to a system and method for approving a task file via a mobile phone.

2. Description of Related Art

Today, people always use a computer to approve task files in their task through a virtual private network (VPN) when they are out for business. Although using a VPN can make people's point-to-point communications in a safe and efficient way, many problems may arise when the VPN behaves abnormally.

Accordingly, what is needed is a system and method for amending the above-mentioned deficiencies of the VPN.

### BRIEF DESCRIPTION OF THE DRAWINGS

FIG. 1 is a schematic diagram of one embodiment of a system for approving a task file via a mobile phone;

FIG. 2 is a block diagram of function modules of an application server of FIG. 1;

FIG. 3 is a block diagram of a task list stored in a storage system of the application server of FIG. 2;

FIG. 4 is a flowchart of one embodiment of a method for approving a task file via a mobile phone.

### DETAILED DESCRIPTION OF CERTAIN INVENTIVE EMBODIMENTS

All of the processes described below may be embodied in, and fully automated via, functional code modules executed by one or more general purpose computers or processors. The code modules may be stored in any type of computer-readable medium or other computer storage system device. Some or all of the methods may alternatively be embodied in specialized computer hardware.

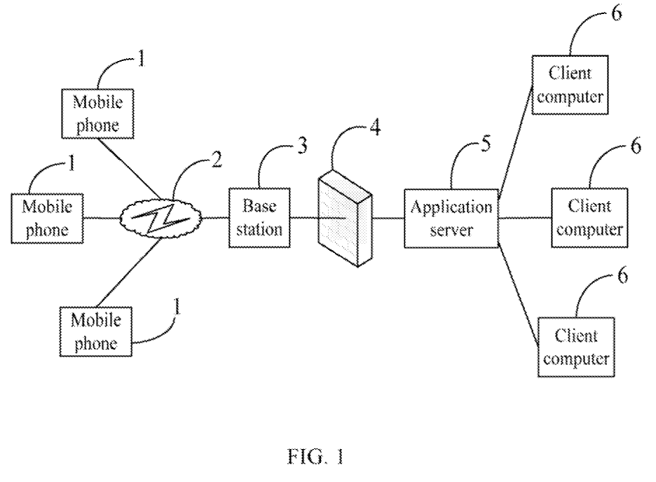

FIG. 1 is a block diagram of one embodiment of a system for approving a task file via a mobile phone. In one embodiment, the system includes one or more client computers 6, an application server 5, and one or more mobile phones 1 communicated with the application server 5 through a network 2, a base station 3 and a firewall 4. The network 2 can be a 3^{rd} generation (3G) network, or any other suitable type of communication link. The firewall 4 is configured for preventing the application server 5 from being corrupted by computer viruses, trojan horses, worms, or any other malicious programs and/or hackers with malicious intent. The one or more client computers 6 are configured for providing files to be approved by the one or more mobile phones 1.

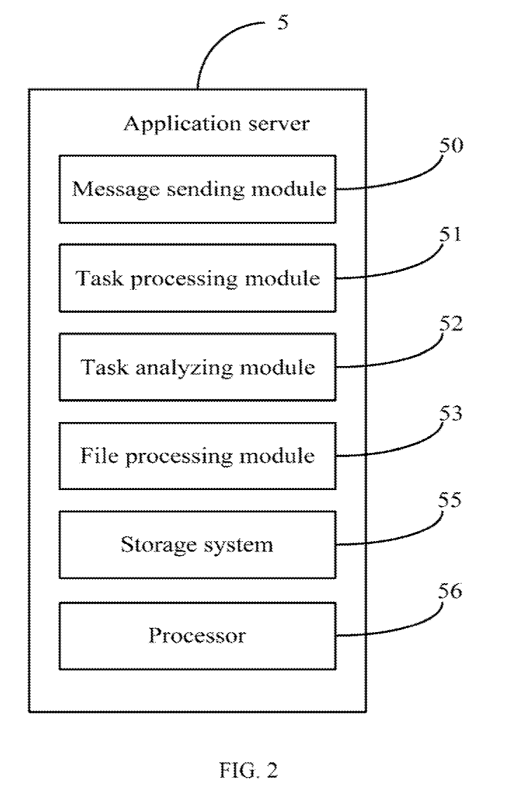

FIG. 2 is a block diagram of function modules of the application server 5. In one embodiment, the application server 5 includes a message sending module 50, a task processing module 51, a task analyzing module 52, a file processing module 53, a storage system 55, and a processor 56. The modules 50, 51, 52, 53 may be used by the processor 56 to execute one or more operations for the application server 5. The storage system may include a hard disk drive, read only memory, random access memory, or a combination thereof.

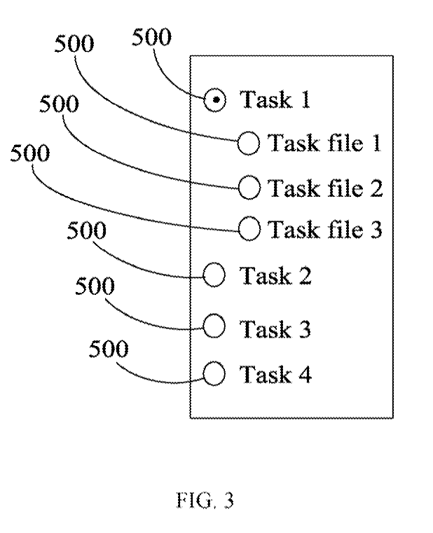

The storage system 55 is configured for storing at least one task. Each of the at least one task comprises at least one task file for the application server 5. Each of the at least one task, and each task file in the at least one task are listed in a task list. The task list as shown in FIG. 3 includes task 1, task 2, task 3, and task 4; the task 1 includes task file 1, task file 2, and task file 3; each task and each task file listed in the task list have an option 500. The option 500 may be a radio button or a checkbox depending on the embodiment.

The message sending module 50 is configured for sending a reminder message to the mobile phone 1 via a communication network including the base station 3 and the firewall 4. The reminder message indicates that one or more task files of the at least one task need to be approved. The reminder message can be an E-mail, a short message, or any other suitable type of messaging.

The task processing module 51 is configured for providing options to the mobile phone 1 to select a task from the at least one task according to the reminder message, and is configured for providing detailed information of selected task to the mobile phone 1. The detailed information of the selected task include all task files of the selected task, a guide of performing the selected task, a flow of processing the selected task, and needed content of each task file in the at least one task. The options provided by the task processing module 51 are schematically shown as the options 500 in FIG. 3.

The task analyzing module 52 is configured for analyzing if a digital signature is requested to be applied on a task file according to the reminder message. The task analyzing module 52 is further configured for providing two options for determining whether to apply the digital signature on the task file according to the detailed information of the selected task, upon the condition that the digital signature is requested to be applied on the task file. The two options includes an option for applying the digital signature on the task file (hereafter, “accept option”), thereby approving the task file, and an option for denying application of the digital signature on the task file (hereafter, “deny option”). The digital signature is requested to be applied on the task file upon the condition that the task file comprises the needed content.

The file processing module 53 is configured for applying the digital signature in the task file to form an approved task file upon the condition that the accept option is selected. The file processing module 53 provides a file processing interface to the mobile phone 1 for a user to select the accept option.

The task analyzing module 52 is further configured for analyzing if the task list has any other task to be selected.

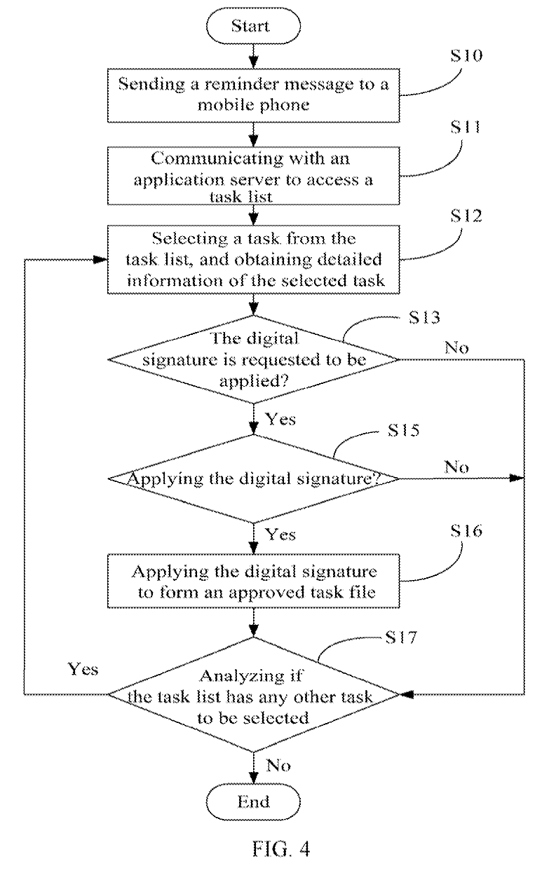

FIG. 4 is a flowchart of one embodiment of a method for approving a task file via a mobile phone in accordance with the present disclosure. Depending on the embodiment, additional blocks may be added, others removed, and the ordering of the blocks may be changed.

In block S10, a mobile phone 1 receives a reminder message sent from the message sending module 50 of the application server 5. The message indicates that one or more task files of the at least one task in the storage system 55 need to be approved, wherein each of the at least one task includes at least one task file. Each of the at least one task, and each task file in the at least one task are listed in a task list.

In block S11, the user of the mobile phone 1 establishes communication between the mobile phone and the application server 5 according to the reminder message so as to access the task list.

In block S12, the task processing module 51 provides options to the mobile phone 1 to select a task from the at least one task according to the reminder message, and provides detailed information of the selected task to the mobile phone 1. The detailed information of the selected task include all task files of the selected task, a guide of performing the selected task, a flow of processing the selected task, and needed content of each task file in the at least one task.

In block S13, the task analyzing module 52 analyzes if the digital signature is requested to be applied on a task file of the selected task according to the reminder message.

If the selected task does not request to apply the digital signature, then the procedure goes directly to block S17 described below. Otherwise, if the digital signature is requested to be applied on the task file of the selected task, in block S 15, the task analyzing module 52 provides two options for determining whether to apply the digital signature on the task file according to the detailed information of the selected task, upon the condition that the digital signature is requested to be applied on the task file. As mentioned above, the two options includes the accept option, thereby approving the task file, and the deny option. The digital signature is requested to be applied on the task file upon the condition that the task file comprises the needed content.

If the deny option is selected, then the procedure goes directly to block S17 described below. Otherwise, if the accept option is selected, in block S 16, the file processing module 53 applies the digital signature in the task file to form an approved task file.

In block S17, the task analyzing module 52 analyzes if the task list has any other task to be selected.

If the task list has any other task to be selected, then the procedure goes directly to block S12 described above. Otherwise, if the task list has no task to be selected, then the procedure ends.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. An application server for approving a task file via a mobile phone, the application server comprising:
a storage system configured for storing at least one task of the application server, each of the at least one task comprising at least one task file;
a message sending module configured for sending a reminder message to the mobile phone via a communication network, the reminder message indicating that one or more task files of the at least one task need to be approved;
a task processing module configured for providing options to the mobile phone to select a task from the at least one task according to the reminder message, and configured for providing detailed information of the selected task to the mobile phone;
a task analyzing module configured for analyzing if a digital signature is requested to be applied on a task file according to the reminder message, and configured for providing an accept option for applying the digital signature on the task file and an deny option for denying application of the digital signature on the task file according to the detailed information of the selected task, upon the condition that the digital signature is requested to be applied on the task file;
a file processing module configured for applying the digital signature in the task file to form an approved task file upon the condition that the accept option is selected; and
a processor that executes the message sending module, the task processing module, the task analyzing module, and the file processing module.

2. The application server as claimed in claim 1, wherein each of the at least one task, and each task file in the at least one task are listed in a task list.

3. The application server as claimed in claim 1, wherein the detailed information of the selected task comprise all task files of the selected task, a guide of performing the selected task, a flow of processing the selected task, and needed content of each task file in the at least one task.

4. The application server as claimed in claim 3, wherein the digital signature is requested to be applied on the task file upon the condition that the task file comprises the needed content.

5. A computer-implemented method for approving a task file via a mobile phone, the method comprising:
(a) sending a reminder message to the mobile phone via a communication network, the reminder message indicating that one or more task files of at least one task in a storage system of an application server need to be approved, wherein each of the at least one task comprises at least one task file;
(b) establishing communication between the mobile phone and the application server via the communication network;
(c) providing options to the mobile phone to select a task from the at least one task according to the reminder message, and providing detailed information of the selected task to the mobile phone;
(d) analyzing if a digital signature is requested to be applied on a task file of the selected task according to the reminder message;
(e) providing an accept option for applying the digital signature on the task file and an deny option for denying application of the digital signature on the task file according to the detailed information of the selected task, upon the condition that the digital signature is requested to be applied on the task file; and
(f) applying the digital signature in the task file to form an approved task file upon the condition that the accept option is selected.

6. The method as claimed in claim 5, wherein each of the at least one task and each task file in the at least one task are listed in a task list.

7. The method as claimed in claim 6, further comprising blocks of:
(g) analyzing if the task list has any other task to be selected.
(h) going to step (g) if the selected task does not request to apply the digital signature;
(i) going to step (g) if the deny option is selected; and
(j) going to step (c) if the work list has any other task to be selected.

8. The method as claimed in claim 5, wherein the detailed information of the selected task comprise all task files of the selected task, a guide of performing the selected task, a flow of processing the selected task, and needed content of each task file in the at least one task.

9. The method as claimed in claim 8, wherein the digital signature is requested to be applied on the task file upon the condition that the task file comprises the needed content.

10. A computer-readable medium having stored thereon instructions for approving a file via a mobile phone that, when executed by an application server, cause the application server to perform a method, the method comprising:
(i1) sending a reminder message to the mobile phone via a communication network, the reminder message indicating that one or more task files of at least one task in a storage system of an application server need to be approved, wherein each of the at least one task comprises at least one task file;
(i2) establishing communication between the mobile phone and the application server via the communication network;
(i3) providing options to the mobile phone to select a task from the at least one task according to the reminder message, and providing detailed information of the selected task to the mobile phone;
(i4) analyzing if a digital signature is requested to be applied on a task file of the selected task according to the reminder message;
(i5) providing an accept option for applying the digital signature on the task file and an deny option for denying application of the digital signature on the task file according to the detailed information of the selected task, upon the condition that the digital signature is requested to be applied on the task file; and
(i6) applying the digital signature in the task file to form an approved task file upon the condition that the accept option is selected.

11. The medium as claimed in claim 10, wherein each of the at least one task and each task file in the at least one task are listed in a task list.

12. The medium as claimed in claim 11, wherein the method further comprising:
(i7) analyzing if the task list has any other task to be selected.
(i8) going to step (i7) if the selected task does not request to apply the digital signature;
(i9) going to step (i7) if the deny option is selected; and
(i10) going to step (i3) if the work list has any other task to be selected.

13. The medium as claimed in claim 10, wherein the detailed information of the selected task comprise all task files of the selected task, a guide of performing the selected task, a flow of processing the selected task, and needed content of each task file in the at least one task.

14. The medium as claimed in claim 13, wherein the digital signature is requested to be applied on the task file upon the condition that the task file comprises the needed content.
